(19) United States
(12) Patent Application Publication
(10) Pub. No.: US 2005/0207819 A1
(43) Pub. Date: Sep. 22, 2005

(54) Method and marking instrument for gaming playslips

(76) Inventor: Alvin Don Mosier, Sterling, VA (US)

Correspondence Address: Alvin Don Mosier, 20559 Shadow Wood Ct, Sterling, VA, 20165-7338, US

(21) Appl. No.: 10/805,462

(22) Filed: Mar. 20, 2004

(51) Int. Cl. B43K 5/00; A46B 5/02

(52) U.S. Cl. 401/6; 401/195

(57) ABSTRACT

The Pyramidal Marking Instrument includes triangular cross-section cap and casing, having pyramid-shaped, pyramidal-shape facet shape. The shape of the marking instrument enhances the user's gaming experience by inferring superstitions therefrom.

### FIELD OF THE INVENTION

This invention relates to methods and apparatuses for playing games of chance. More specifically, this invention relates to a gaming playslip marking device and method thereof having a form that enhances the user's expectation and willingness to participate in the game.

### BACKGROUND OF THE INVENTION

Thousands of people play the game of “Lottery” that may include Keno, Pick-3, Pick-4, Pick-5, Cash-5, Lotto, The Big Game Mega Millions, Powerball, etc., and these players are dedicated, loyal, and committed to their chosen game or games. These games are generally played at State approved facilities or may be played by mail. The game utilizes playslips, which may be referred, to as a “Scantron” form or Scholastic test card or form that typically carry numbers or symbols thereon in rows and columns designed for the game. Numbers or symbols are selected from the rows and columns and are marked or scored in the provided spaces for the selected game.

It is well-known and established that gaming and “lottery” sponsors spend millions of dollars on advertising to market to and attract new players as well as retain current players. Also, it is a fact that sponsors rely on a player's proclivity to various superstitious beliefs in their marketing and advertising campaigns.

Examples of such marketing is seen in the various symbols or themes utilized in gaming playslips, such as scratch-off games. For example, lucky zodiac symbols are used in some instances, as well as four-leaf clovers, queen of spades, crossed-fingers, various numbers, and so forth. A particular example of advertising based on the association is the Commonwealth of Virginia's “Lady Luck” character who has become their spokesperson, mascot, for the State Lottery. She [“Lady Luck”] is seen in commercials, on the official homepage of the Virginia Lottery, and in statewide ad campaigns where posters, flyers, and other advertising inundate the citizens of Virginia—all for the purpose to generate revenue by which is primarily done through marketing and catering to people's superstition, belief in or support of chance or destiny. All of the aforementioned advertising or marking has been directed to an association of the gaming playslip or some random occurrence. However, there has yet to be provided an advertising or marking practice that physically reinforces some of the desired associations with respect to the actual “act” of playing the game, to increase or further engage participants. Therefore, there has been a long-standing need in the gaming industry for methods and apparatuses that enhance the desired association during the act of playing the game.

### SUMMARY OF THE INVENTION

It is therefore a feature and advantage of this invention to enhance a participant's willingness to participate in a game of chance by providing a marking tool that reinforces the player's associations with luck or chance. In a preferred embodiment of this invention, a pyramidal shaped marking device is devised for specifically marking gaming playslips or cards with a pyramidal mark in reliance on various players' association with pyramid “power”. In another preferred embodiment of the invention, a lottery writing instrument, specifically a Pyramidal Marking Instrument that provides a mechanism of imprinting, marking and/or ink-stamping lottery and other gaming playslips that provides for recreational, entertainment, fun and amusement use, which may enhance the user's experience surrounding its use and application, and attract new lottery players and increase existing lottery player retention and more frequent playing.

The writing instrument and its perceived superstitious metaphysical properties are related to its outer casing, its inner inked core-element tip/nib and center-inked core-element filler being a triangular cross-section in shape, with a textured triangular cross-section contour in shape, look and feel, and its internal imprinting, marking and/or ink-stamping mechanism being a triangular cross-section in shape and utilizes dark ink, which is representative of a pyramid's shadow. The overall pyramid-like feature of the invention allows the user a more perceived focused application of the user's beliefs.

Accordingly, several objects and advantages of the invention are to provide a lottery writing instrument for marking gaming playslips, enhance the user's experience, to promote lottery gaming, to attract new lottery players, to provide more utility, to provide satisfaction and fulfillment, to provide effectiveness and efficiency, to provide useful, concrete, and tangible results, and to provide a better way to fill out and/or mark lottery and other gaming playslips. Still further objects and advantages will become clear from the examination of the following description and associated drawings.

### BRIEF DESCRIPTION OF THE DRAWINGS

FIG. 1 is a perspective right-sided view of an exemplary instrument in accordance with the invention.

FIG. 2 is a perspective left-sided view of an exemplary instrument in accordance with the invention.

FIG. 3 is a lateral cross-sectional view of an exemplary instrument in accordance with the invention, with the cap removed.

FIG. 4 is a lateral cross-sectional view of an exemplary instrument in accordance with the invention, with the cap on.

FIG. 5 is a perspective view of an exemplary instrument in accordance with the invention, showing its core-element.

FIG. 6 is a perspective view of an exemplary multi-tiered instrument in accordance with the invention, showing its core-element.

### DETAILED DESCRIPTION OF THE DRAWINGS

It is a well-documented fact that people believe in some properties of “power”, “healing force” or “mysterious benefit” whether for health or wealth in the pyramids and like structures. For example, there have been hats made for people to wear that is believed to enhance the wearer's thinking and learning abilities, some have made beds, gardens, etc. in pyramidal structure that may harness some natural “healing” or “helping” force or energy.

Usually, a regular soft pencil or pen is used to mark the games of chance playslip. There are negative aspects to using a pencil or pen; the use of pencils and pens can be tedious—markings made by horizontal, vertical and otherwise axis hand movements or motions to mark the numbered space on a “Scantron” form or Scholastic test card or any State-approved gaming playslip form, may be misread by the lottery machine, may cause writer's cramp that can extend the time of marking the gaming playslips, which can deny the user precious time, causing the user to miss the gaming cut-off time thus, missing an opportunity of winning.

Writing instruments, and marking devices are largely a matter of style, effect, and utility—that is, providing the user with their fit of purpose to suit the existing need—and a matter of providing the user with a freedom of expression. These two facets of a writing instrument, specifically to a marker and/or ink-stamping devices can contradict one another and may lead a user to sacrifice one over the other.

Accordingly, there is a clear need in the art for a Pyramidal Marking Instrument for imprinting, marking, and/or ink-stamping gaming playslips that do not require markings made by horizontal, vertical and otherwise axis hand movements or motions across the numbered space on the gaming playslip's surface, for the recreational, entertainment, experience, fun and amusement use.

Such devices are typified by their disclosures and discussions in the background sections of U.S. Pat. Nos. 78,446, 10,4967, 1,267,521, 201,048, 2,314,394, 2,517,060, 2,604,693, 3,006,024, 3,565,294, 3,750,729, 3,858,986, 405,704, 4,509,875, 454499, 669137, 827,347, 1,025,019, 1,042,766, 1,121,940, 1,345,255, 1,478,157, 1,850,086, 2,079,080, 2,102,044, 2,192,644, 2,312,727, 2,416,596, 2,673,649, 2,919,645, 2,939,390, 3,216,352, 3,251,299, 3,281,887, 3,364,856, 3,402,663, 3,446,563, 3,631,799, 3,666,373, 3,755,517, 3,932,251, 3,952,653, 3,988,987, 4,380,403, 4,389,132, 4,432,281, 4,469,464, 4,529,328, 4,558,966, 4,560,297, 4,823,696, 4,852,489, 4,859,104, 4,865,479, 4,924,773, 4,970,954, 5,018,894, 5,051,015, 5,052,838, 5,152,223, 5,197,616, 522,823, 5,284,273, 5,336,011, 5,451,114, 5,547,301, 5,678,941, 5,713,681, 5,885,020, 5,904,433, 5,938,081, 5,984,550, and 5,988,923, 6,454,479, 6,481,908, et al., and are incorporated by reference herein in its entirety.

The main purpose of the present invention relates to games of chance marking instrument. More specifically, this invention relates to an imprinter, marker and/or ink-stamping device, that provides a mechanism to allow the user to imprint, mark and/or ink-stamp gaming playslips of such games as Keno, Pick-3, Pick-4, Pick-5, Cash-5, Lotto, The Big Game Mega Millions, Powerball, etc. It is a further purpose of the invention to provide a games of chance marking instrument, specifically relating to an imprinter, marker and/or ink-stamping device, that provides a mechanism for recreational, entertainment, fun and amusement use accordingly to the participant's use, which may attract more frequent players and induce new players to the gaming experience. Thus, increasing revenue for the state and/or sponsors, which can be used for educational purposes, infrastructure support, and other support programs.

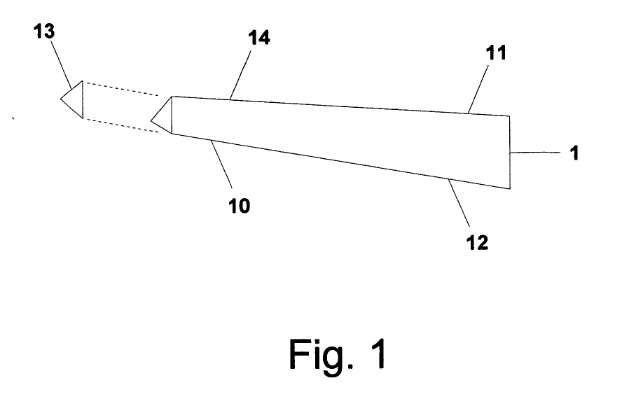

FIG. 1 is a perspective view taken from the user's right side of the exemplary instrument 1, showing the upper half of the instrument 1 in accordance with the invention, lower portion of marking instrument casing 10, upper longitudinal edge of marking instrument casing 11, upper portion of marking instrument casing 12, marking instrument cap 13, and lower longitudinal edge of marking instrument casing 14, of the instrument in accordance with the invention

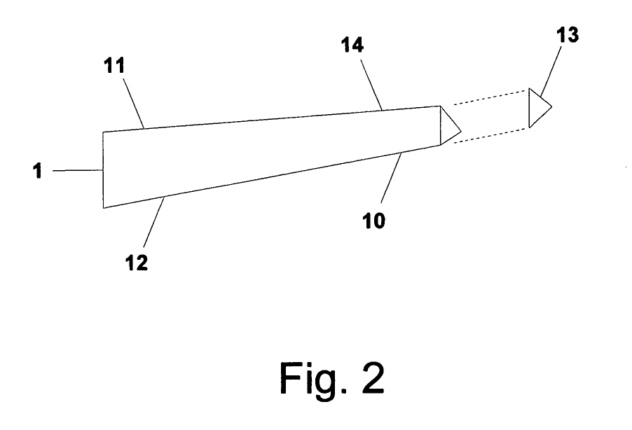

FIG. 2 is a perspective view taken from the user's left side of the exemplary instrument 1, showing the upper half of the instrument 1 in accordance with the invention, lower portion of marking instrument casing 10, upper longitudinal edge of marking instrument casing 11, upper portion of marking instrument casing 12, marking instrument cap 13, and lower longitudinal edge of marking instrument casing 14, of the instrument in accordance with the invention

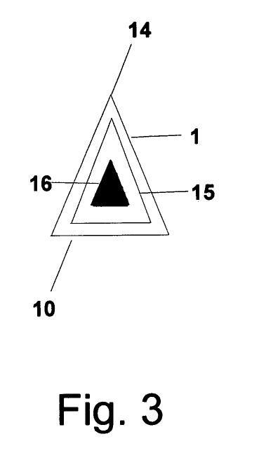

FIG. 3 is a lateral cross-sectional view taken from the front and through the exemplary instrument 1, showing the lower half of the instrument in accordance with the invention, with the cap removed, lower portion of marking instrument casing 10, lower longitudinal edge of marking instrument casing 14, inner inked core-element shaft of the marking instrument casing 15, and inked core-element tip/nib of marking instrument 16, of the instrument in accordance with the invention.

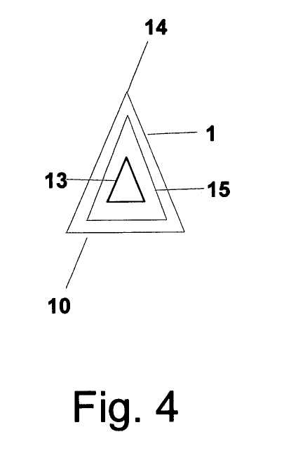

FIG. 4 is a lateral cross-sectional view taken from the front and through the exemplary instrument 1, showing the lower half of the instrument in accordance with the invention, with the cap on, lower portion of marking instrument casing 10, marking instrument cap 13, inner inked core-element shaft of the marking instrument casing 15, and inked core-element tip/nib of marking instrument 16, of the instrument in accordance with the invention.

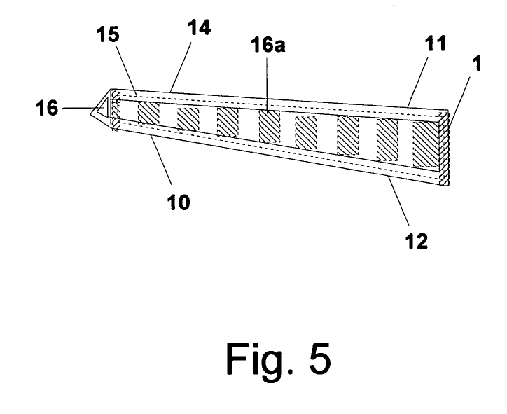

FIG. 5 is a perspective cross-sectional view taken from the user's right side through the exemplary instrument 1, showing the lower portion of marking instrument casing 10, upper longitudinal edge of marking instrument casing 11, upper portion of marking instrument casing 12, lower longitudinal edge of marking instrument casing 14, inner inked core-element shaft of the marking instrument casing 15, inked core-element tip/nib of marking instrument 16, and inner inked core-element of marking instrument 16a, of the instrument in accordance with the invention.

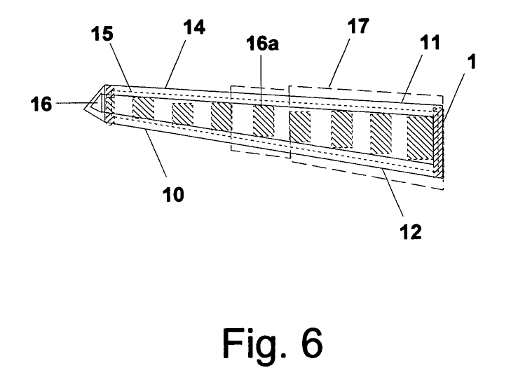

FIG. 6 is a perspective cross-sectional view taken from the user's right side through the exemplary instrument of the present invention 1 having a multi-tiered casing, showing the lower portion of marking instrument casing 10, upper longitudinal edge of marking instrument casing 11, upper portion of marking instrument casing 12, lower longitudinal edge of marking instrument casing 14, inner inked core-element shaft of the marking instrument casing 15, inked core-element tip/nib of marking instrument 16, and inner inked core-element of marking instrument 16a, and upper portion of multi-tiered marking instrument casing 17, of the instrument in accordance with the invention.

While particular embodiments of the invention have been shown and described, it will be obvious to those skilled in the art that changes and modifications may be made without departing from the invention in its broader aspects, and therefore, the aim in these claims is to cover all such changes and modifications as fall within the true spirit and scope of the invention.

In operation, a user holds the exemplary instrument 1 in a normal manner as one would hold a marker, pencil, or pen, and by pressing the outer casing downwards until the instrument's inked core-element tip/nib 16 is pressed on to the gaming playslips' surface that is to be imprinted, marked or ink-stamped. The user can, when marking and/or ink-stamping the gaming playslips, increase the intensity of the mark by applying various amounts of downward pressure on to the gaming playslips' surface. The imprints, markings and/or ink-stampings made on the playslips must be within the gaming playslip's number or symbol associated box for proper reading operation by the gaming industry's machine.

When used as intended, three effects increase the writing instrument's benefit, use and utility, which produce useful, concrete, and tangible results.

The inked core-element tip/nib 16, of marking instrument is, in accordance with the present invention, a triangular cross-section having a pyramid-shaped, pyramidal-shape facet that may be made of bonded polyester or nylon fibers or may be made of sintered ultra high molecular weight polyethylene material or of like material which provides an application and transference of a dark ink mark on to lottery gaming playslips, which may enhance the user's experience, and success by tapping into the perceived superstitious “powers of the pyramid” or “pyramidal energy transference (“PET”)”and dimensionally affords the proper size, application, and provides a better way to mark on to lottery gaming playslips.

The casing is, in accordance with the present invention, a triangular cross-section, having a pyramid-shaped, pyramidal-shape facet, the surface area of the casing with a textured contour in shape, look and feel, its inked core-element tip/nib, its inked core-element, a triangular cross-section, having a pyramid-shaped, pyramidal-shape facet, and its internal marking mechanism, a triangular cross-section, having a pyramid-shaped, pyramidal-shape facet, and utilizes dark ink, which is representative of a pyramid's shadow, of the marking instrument 1, provides for freedom of movement and ease of use, and the user's exposure to writer's cramp is reduced.

It should be appreciated that the various aspects of this invention provide an enhanced user's experience and, thereby promote or increase the frequency of gaming for users. Of course, the implementation of this invention is not to “tap” into any form of pyramidal power, as there has been no scientific proof, as to such. However, with the use of this invention and its respective methods, it is well anticipated that gamers will prefer a marking instrument with pyramidal associations. Accordingly, gaming sponsors could significantly benefit from such an inventive device and method, therein.

1. A shaped gaming playslip marking instrument having a pyramidal form, comprising:
an elongated core having a substantially triangular cross-section of proportions akin to a side of a pyramid (pyramidally triangular), the core having a marking end whose face is substantially pyramidally triangular;
a substantially pyramidally triangular casing about said core extending through out a length of said core; and
a removable portion of said casing at an end of said casing to expose the face of said core,
wherein ends of the casing form pyramidally triangular faces.

2. The marking instrument according to claim 1, further comprising:
ink in the core.

3. The marking instrument according to claim 1, wherein the casing is made of an acrylonitrile-butadiene-styrene resin (ABS).

4. The marking instrument according to claim 1, wherein the casing is made of a non-acrylonitrile-butadiene-styrene resin (non-ABS).

5. The marking instrument according to claim 1, wherein the removable portion of the casing is a securable cap.

6. The marking instrument according to claim 1, wherein the cross-section of the core and the casing are uniform through out the length of the marking instrument.

7. The marking instrument according to claim 1, wherein the cross-section of the core is non-uniform though out the length of the marking instrument.

8. The marking instrument according to claim 1, wherein the cross-section of the casing is non-uniform through out the length of the marking instrument.

9. The marking instrument according to claim 1, further comprising:
an inner core support casing of a substantially pyramidally triangular cross-section, the support casing being interior to the casing and exterior to the core, and being longitudinally terminated to expose the face of the core.

10. A gaming playslip marking instrument, comprising:
ink-core means of a substantially triangular cross-section of proportions akin to a side of a pyramid (pyramidally triangular) for containing ink, the ink-core means having an end face for marking; and
a protective means for protecting the ink-core means from exposure, the protective means having a pyramidally triangular cross-section and a removable end to expose the ink-core means.

11. A method for enhancing a user's gaming experience, comprising the steps of:
providing a gaming playslip to the user;
utilizing a marking core of a substantially triangular cross-section of proportions akin to a side of a pyramid (pyramidally triangular) and a substantially pyramidally triangular casing cross-section to mark the gaming playslip,
wherein the shape of the marking instrument invokes the user's belief in superstitious pyramidal power.

12. The method according to claim 10, wherein the gaming playslip is of a scantron form.
